(19) United States
(12) Patent Application Publication
(10) Pub. No.: US 2012/0257703 A1
(43) Pub. Date: Oct. 11, 2012

(54) CHARGED PARTICLE GENERATOR

(75) Inventors: Neil Bliss, Widnes (GB); Susan Smith, Warrington (GB); Bruno Muratori, Warrington (GB); Shinji Machida, Abingdon (GB); Robert Cywinski, Slaithwaite (GB); Christopher Prior, Cumnor (GB)

(73) Assignee: THE SCIENCE AND TECHNOLOGY FACILITIES COUNCIL, Chilton, Didcot, Oxon (GB)

(21) Appl. No.: 13/517,488

(22) PCT Filed: Dec. 21, 2010
(86) PCT No.: PCT/GB2010/002306

§ 371 Date: Jun. 20, 2012

(30) Foreign Application Priority Data
Dec. 21, 2009 (GB) 0922352.0

(51) Int. Cl. H01J 27/02; G21G 1/10

(52) U.S. Cl. 376/192; 250/424; 250/423 R

(57) ABSTRACT

The present invention relates to a charged particle beam generator comprising multiple charged particle beam generator units. In particular, the present invention is concerned with apparatus for generating a high-energy, high-current proton beam such as are used in accelerator driven subcritical reactors. The present invention provides a method of generating a composite proton beam using a proton beam generator comprising multiple proton beam generator units. A negative hydrogen ion source is used to generate a beam of negative hydrogen ions in each unit. The negative hydrogen ions are stripped to create a proton beam in each unit, that is accelerated beam and guided to a common point where the beams are merged to form the composite proton beam.

The present invention relates to a charged particle beam generator comprising multiple charged particle beam generator units. In particular, the present invention is concerned with apparatus for generating a high-energy, high-current proton beam.

Charged particle beam generators are well known. They generally comprise a source of the charged particle that may provide a desired ion or charged subatomic particle. An injector is used to form a charged particle beam from the charged particles produced by the source. The charged particles are accelerated to the required energy using an accelerator, and delivered to a target via a transfer line. The accelerator may form the charged particle beam, or may receive an already formed charged particle beam. Many different types of charged particles are handled in this way, from subatomic particles such as electrons and protons, to light ions like elementary particles (B⁺, Ga⁺) and heavy organic ions such as are found in biological sample analysis.

Proton beams are of particular interest to the present invention as a need exists for an improved source of high-energy, high-current proton beams. While it is possible to generate high-energy, high-current proton beams, efforts to date have produced apparatus that suffer from problems with reliability. If it were possible to provide an apparatus that is capable of providing a stable and reliable high-energy, high-current proton beam, many fields of technology would benefit.

For example, one application that would benefit from such a proton beam is accelerator driven subcritical reactors. Accelerator driven subcritical reactors are also known as energy amplifiers because a fraction of the energy produced by the nuclear reactor is fed back to power the particle accelerator that provides the proton beam. In conventional energy-producing nuclear reactors, the fission process is critical such that the fission itself generates the neutrons required to sustain the reaction. By definition, a subcritical reaction requires a feed of neutrons for the fission process to be sustained. One way of providing a source of neutrons is through spallation. A high-energy proton beam is used to deliver a stream of protons to a spallation target, typically contained within a fuel rod. Spallation sees the protons strike the target, causing the target nuclei to eject particles including the desired stream of neutrons. However, the fission reaction is sensitive to the delivery of the proton beam, such that even short-lived drop-outs in the proton beam disrupt the neutron production enough to stop the fission reaction. Thus, efforts to date have met with only limited success due to the aforementioned unreliability of proton beam generators.

Realising a reliable accelerator driven subcritical reactor would provide many benefits over conventional energy-producing nuclear reactors. For example, a greater choice of nuclear fuel is available such that more advantageous fuels than uranium and plutonium may be used. A promising candidate is thorium. Thorium is not a fissile material, but it is fertile such that is can be converted to fissile ²³³U, according to the following reaction:

²³²Th+n→²³³Th→²³³Pa+β⁻→²³³U+β⁻

Thorium has received much interest owing to a number of advantages it holds over uranium (and plutonium), such as:
1. Thorium is three times more abundant in the earth's crust than uranium.
2. The thorium found in the earth's crust does not require costly enrichment in the way that uranium does. As a result, pure thorium fuel rods may be used that are then converted to a thorium/uranium mixture as spallation occurs.
3. The reaction scheme of thorium produces almost no plutonium, thus making it a good candidate as a non-proliferation nuclear fuel source.
4. The radioactive waste produced is far shorter-lived, easing disposal problems.

The particle accelerators proposed for use with accelerator driven subcritical reactors can adopt one of several conventional schemes. In one example, a source feeds an injector that injects negative hydrogen (H⁻) ions into a linear accelerator (linac). The linac accelerates the ions, and then injects the ions into a synchrotron. At injection two electrons are stripped from each H⁻ ion to produce a proton. In the synchrotron, the proton energy is boosted once more to the desired beam energy. The synchrotron may also be used to accumulate protons to achieve a desired beam current. The protons are then taken from the synchrotron and directed to a reactor where they are fired into the spallation target to produce the neutrons that convert the fertile thorium to fissile uranium.

It is an object of the present invention to build on current accelerator designs so as to produce a particle accelerator that may produce a reliable high-energy, high-current beam of particles that is suitable for use with an accelerator driven subcritical reactor.

Against this background, and from a first aspect, the present invention resides in a method of generating a composite proton beam using a proton beam generator comprising n proton beam generator units where n is at least two. In each of the n proton beam generator units, an H⁻ source is used to generate a beam of ions, the ions are stripped to protons and the proton beam is accelerated and then guided to a common beamline. Thus n proton beams are merged on entry to the beamline to form the composite proton beam.

Providing multiple proton beam generator units adds reliability in that the failure of any one proton beam generator unit does not result in total failure of the ion beam. Furthermore, as will be described in more detail below, further advantageous modifications may be made to the remaining proton beam generator units to compensate for the loss of one unit. In addition, the claimed arrangement allows for individual proton beam generator units to be taken out of commission, for servicing or the like, and yet still provide a composite beam.

The composite proton beam may be formed by merging the n proton beams in different ways. For example, the n proton beams may be pulsed such that they comprise discrete pulses consisting of one or more bunches of protons. These pulses of protons may be merged into a single channel in such a way that they arrive at the spallation target at the same time.

Alternatively, the pulses may be merged sequentially in the common beamline so as to arrive at the target separated in time. The proton pulses in the n proton beams may have a substantially common repetition rate, i.e. all proton beams have proton pulses separated by the same length of time. The proton pulses may be interleaved such that the proton pulses in the composite proton beam are also equally spaced. In this way, a composite proton beam is formed that has a repetition rate n times that of the n proton beams.

Each of the n proton beams may have substantially the same beam current.

Should one of the n proton beam generator units stop producing a proton beam, for example because of failure or due to being taken out of commission for servicing, the method may further comprise increasing the repetition rate of the proton pulses in the n−1 remaining proton beams by a factor of (n−1)/n. In this way, the beam current may be preserved, along with the regularity of the composite proton beam, i.e. there are no “drop outs” due to missing proton pulses. Alternatively, the method may further comprise increasing the beam current in the n−1 remaining proton beams by a factor of n/(n−1). Again, this preserves the beam current although does not “fill in” the missing ion pulses. Of course, a combination of the two techniques may be used, i.e. an increase in repetition rate and an increase in beam current. As a result, it is preferred for the proton generator units to be over-rated for work in the normal method, such that they have the capacity to work harder when one or more of the units is not delivering a proton beam. For example, n+1 accelerators may be working simultaneously, with a chopper that allows only n pulses through. Then there would be no noticeable change if one machine went down or was taken out for repair.

The number of proton beam generator units depends on the beam power requirement at the target. A number in the range 3 to 7 might be anticipated. The composition of each proton beam generator unit may also be varied. For example, more than a single ion source may be used, e.g. a back-up ion source may be included.

Various means may be used to accelerate the proton beam. Linacs, cyclotrons, synchrotrons and fixed-field alternating gradient accelerators (FFAGs) are all suitable. Combinations may also be used. For example, a linac may be used to accelerate an H— ion beam and, after stripping, the proton beam may then be further accelerated in a circular accelerator such as a synchrotron or an FFAG. FFAGs are currently favoured for their speed of operation and their expected reliability.

Two stage FFAGs may also be used, e.g. one stage of acceleration performed in a first FFAG followed by a further stage of acceleration in a second. The FFAG rings could be stacked on top of each other or, if the radii are suitably different, arranged concentrically. The repetition rates of the two FFAGs may be different. For example, a higher repetition rate may be used in the lower energy FFAG to reduce space charge effects: multiple fills from the lower energy FFAG may then be used to populate the higher energy FFAG with protons.

In a contemplated embodiment, a negative hydrogen ion source is used to generate an ion beam, a linac accelerates the ion beam, followed by stripping and further acceleration in an FFAG and still further acceleration in a higher energy FFAG. As an example, the linac may accelerate the H⁻ beam up to around 40 MeV, the lower energy FFAG may accelerate the proton beam up to around 200 MeV, and the higher energy FFAG may accelerate the proton beam up to around 1 GeV. Optionally, the proton beam current may be around 10/n mA to provide a composite proton beam of 10 mA and 10 MW.

The present invention also extends to a method of generating electricity in an accelerator driven subcritical reactor. The method comprises generating a composite proton beam using a proton beam generator in accordance with any of the methods described above. The composite proton beam is then guided to a reactor containing a spallation target and nuclear fuel, such that the proton beam strikes the spallation target. Spallation creates neutrons that travel into the nuclear fuel. Optionally, the nuclear fuel is thorium, and the neutrons cause the fertile thorium to be converted to fissile uranium. Preferably, energy generated by the reactor is fed back to power the ion beam generator.

From another aspect, the present invention resides in apparatus for generating and delivering a composite proton beam to a target. The apparatus comprises n proton beam generator units, each substantially the same as the others. Each of the n proton beam generator units comprises a negative hydrogen ion source operative to generate H⁻ ions. The initial stages of the H⁻ linac may form the ions into a beam.

Two electrons may be stripped from each ion to create protons, and the proton beam may then be accelerated to its final energy. The apparatus further comprises an optical system disposed to receive the n proton beams from the n proton beam generator units and to combine the n proton beams to form the composite proton beam. Merging techniques are well known and have been used, for example, at the CERN proton synchrotron booster for many years.

The proton accelerator of each of the n proton beam generator units may comprise a linear accelerator, a cyclotron, a synchrotron or an FFAG. Optionally, a linear pair of circular accelerators is used. FFAGs are particularly favoured. Preferably, a H⁻ ion accelerator of each of the n proton beam generator units comprises a linac to provide a first stage of acceleration followed by an FFAG to provide a second stage of acceleration. The second stage of acceleration could also be provided by a pair of FFAGs.

The apparatus as described above may also comprise a controller arranged to implement any of the methods described above.

The present invention also extends to an accelerator driven subcritical reactor comprising any of the apparatus described above that is operative to provide a proton beam to a spallation target. The spallation target is located within a reactor core and adjacent a fuel that receives neutrons produced during spallation. For example, the spallation target may be provided within a fuel rod. Preferably, the fuel comprises thorium.

Preferred embodiments of the present invention will now be described, by way of example only, with reference to the accompanying drawings in which:

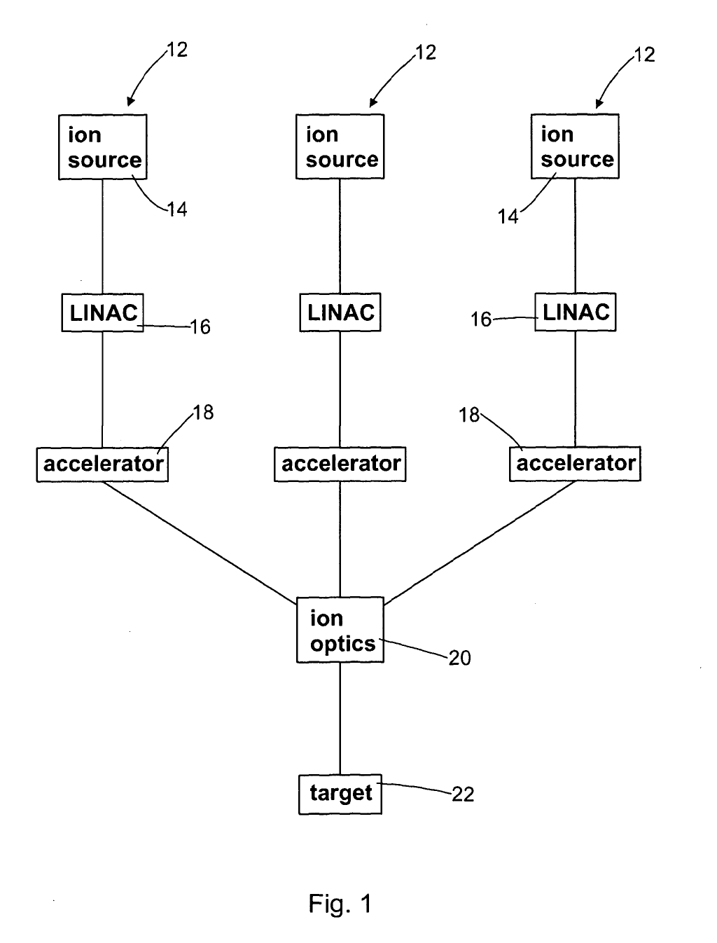

FIG. 1 is a schematic diagram of a proton beam generator and target, including a particle accelerator according to a first embodiment of the present invention;

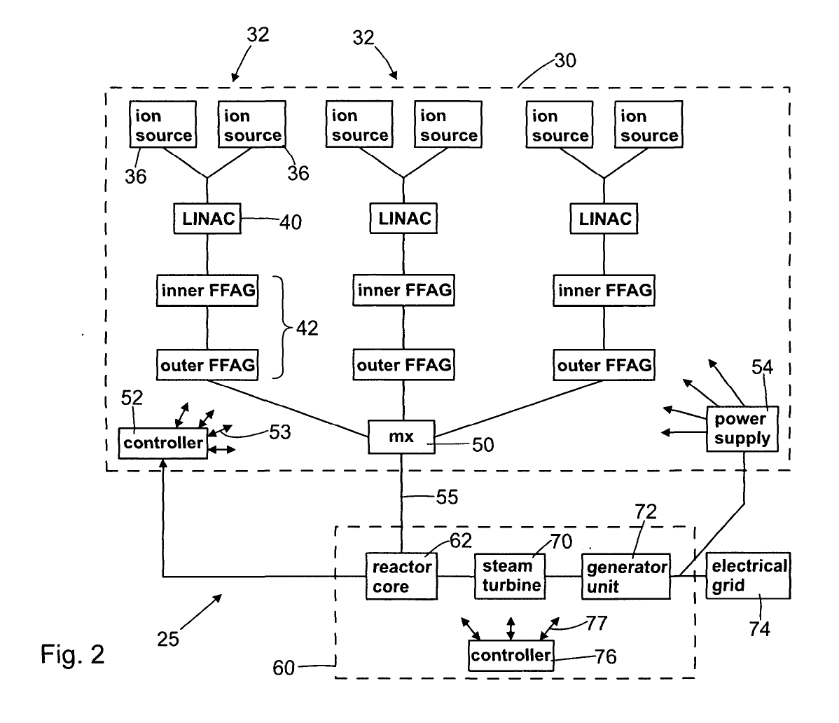

FIG. 2 is a schematic diagram of an accelerator driven subcritical reactor including a particle accelerator according to a second embodiment of the present invention;

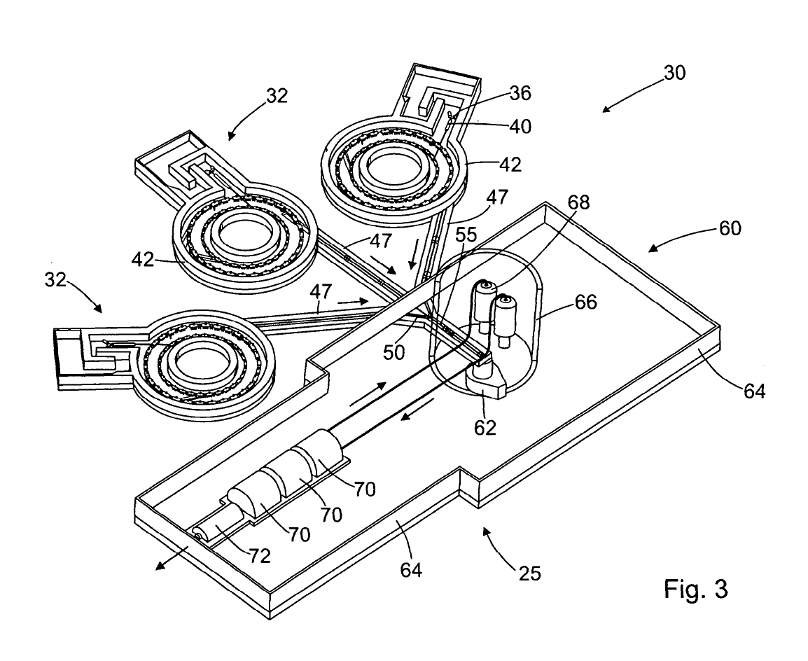

FIG. 3 is a simplified perspective view of the accelerator driven subcritical reactor of FIG. 2; and

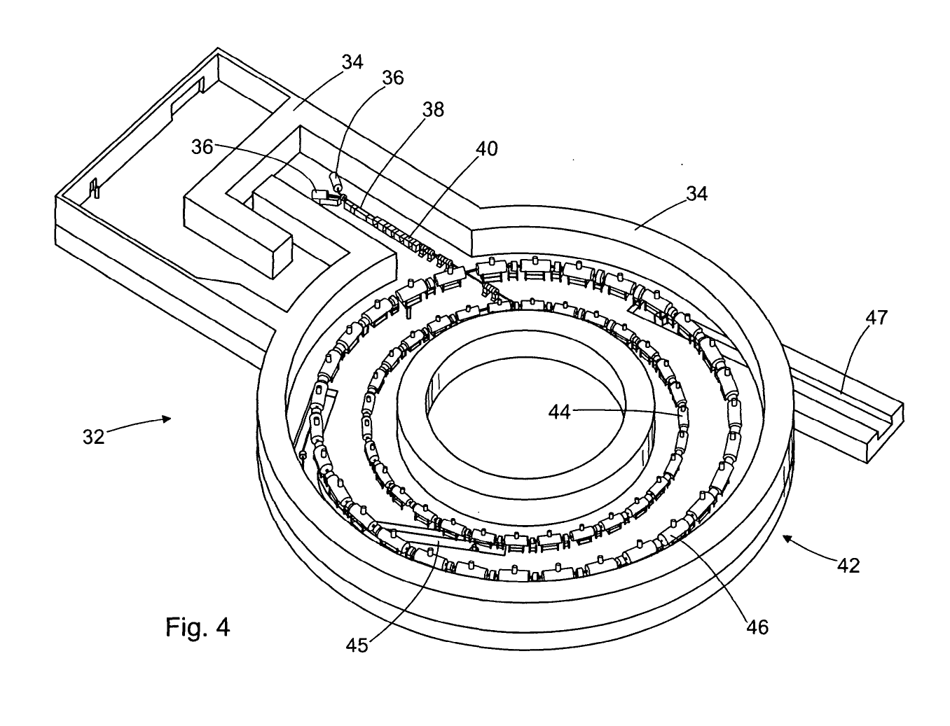

FIG. 4 is a simplified perspective view of one of the accelerator units of FIG. 3.

The present invention provides a proton beam generator that uses multiple particle accelerators to generate and accelerate multiple proton beams that are then brought together to form a composite proton beam. FIG. 1 shows an example of such a proton beam generator 10, comprising three particle accelerator units 12 in this instance.

The three accelerator units 12 are of corresponding design, and produce broadly identical proton beams. Each accelerator unit 12 is formed as follows. Negative hydrogen ions are provided by an ion source 14, such as a Penning source or an electron cyclotron resonance (ECR) source.

Ions generated by the ion source 14 are passed to a linac 16, via a low energy beam transport system (not shown in FIG. 1). The linac is used to accelerate the ions, thereby increasing their energy and momentum. A collimation line (not shown in FIG. 1) transfers the beam of accelerated ions from the linac 16 to a circular accelerator 18, an FFAG in this embodiment.

On entry to the FFAG 18, two electrons are stripped from each negative hydrogen ion so as to create protons. The protons are temporarily stored in the FFAG 18 as further protons from the linac 16 are accumulated as a pulse of protons. The FFAG 18 increases the energy and momentum of the protons still further. In this embodiment, the FFAG 18 is used to raise the energy of the proton beam to the desired final value.

The pulse of protons within each FFAG 18 is extracted by a suitable extraction system (not shown) and sent down a beamline to a kicker system 20 that merges the proton pulses into a single stream. The kicker system 20 may merge the proton pulses to form a single large proton pulse, or may merge the proton pulses sequentially into a train of proton pulses. Forming a suitably spaced train of proton pulses may be achieved by extracting the proton pulses from the FFAGs 18 at appropriate times such that they arrive at the merging kicker system 20 with a suitable time separation. Production of protons is pulsed at a high repetition rate such that a near continuous beam of proton pulses is produced.

The composite proton beam produced by the kicker system 20 is sent down a further beamline to a target 22. As will be appreciated, the target 22 may take many forms.

The proton beam generator 10 may be run continuously to provide a steady stream of proton pulses to the target 22. For example, once the proton pulse has been extracted from an FFAG 18, the ion source 14 may be used to provide the linac 16 with a further set of H⁻ ions that are stripped, accelerated and used to fill the FFAG 18 to form the next proton pulse, and so on. The H⁻ ion source 14 may be switched on or off. Alternatively, the ion source 14 may be left on, but the ions it produces may be selectively sent to the FFAG 18 or not. For example, a beam chopper may be used to deflect ions away from the path to the linac 16 when the FFAG 18 is not being filled. In a further arrangement, the ion source 14 and linac 16 are used to fill the FFAG 18 continuously, and the protons accumulated in the FFAG 18 are extracted periodically.

FIGS. 2 and 3 show an accelerator driven subcritical reactor that includes an accelerator complex 30 according to an embodiment of the present invention. The accelerator complex 30 is used to generate and accelerate a proton beam that is guided to a reactor complex 60. In this embodiment, the reactor complex 60 is fuelled by thorium that is converted to uranium by spallation of a suitable target by the proton beam. Further details of the reactor complex 60 will follow, after a more detailed description of the accelerator complex 30 is provided.

In a preferred embodiment, the accelerator complex 30 comprises seven accelerator units 32, although an embodiment comprising only three of the units 32 is shown in FIGS. 2 and 3 for the sake of simplicity. FIG. 4 shows a more detailed view of one of the accelerator units 32, it being understood that the accelerator units 32 share a common design.

Each accelerator unit 32 is as follows. The accelerator unit 32 is housed within protective walls 34 that provide suitable shielding from the radiation that the accelerator units 32 produce. Negative hydrogen ions are generated in a pair of ion sources 36. Only a single ion source 36 feeds an injector at a time, although both are run continuously. Both ion sources 36 could be used to feed the injector if desired. Providing two ion sources 36 per accelerator unit 32 prevents disruption if one ion source 36 should fail, and also allows one or more ion sources 36 to be taken out of commission for maintenance.

The operating ion source 36 runs continuously to provide a steady stream of H⁻ ions with an average current of around 3 mA. The beamlines from the ion sources 36 allow selection of ions from either or both ion sources 36. In normal operation, the ions continue to a radio frequency quadrupole (RFQ) 38 that prepares the beam for acceleration. The H⁻ ions from the RFQ 38 pass through a beam chopper, which creates gaps in the beam or optionally may be used to dump all ions such that no ions are sent downstream. The linac 40 accelerates the ions up to an energy suitable for injection into the FFAG 44. Two electrons are stripped from each ion using any conventional means.

The resulting protons are passed to a two-stage accelerator 42 comprising a pair of FFAGs. A lower energy FFAG 44 is arranged within a larger-radius higher-energy FFAG 46. As FFAGs are well known, they will not be described in detail here. If the rings have different radii, the layout can see the beamline from the linac 40 pass under the higher energy FFAG 46 to guide the ions into the lower energy FFAG 44. The protons are then accelerated around the lower energy FFAG 44 to provide an increase in momentum and energy. The protons are then transferred to the higher energy FFAG 46 via a beamline 45. The energy of the protons is increased as they circulate in the second FFAG 46, raising the energy of the proton beam up to its final value of 1 GeV.

The 1 GeV proton beam is then guided from the higher energy FFAG 46 along beamline 47 to a multiplexer 50 that interleaves the proton beams received down the beamlines 47. Each cycle of generating protons, populating the higher energy FFAG 46 and extracting the protons is completed in the order of milliseconds.

The accelerator complex 30 operates under the control of a controller 52. A single controller 52 may be provided to control all the accelerator units 32, or each accelerator unit 32 may have its own dedicated controller 52. In addition to issuing signals to effect control of the accelerator units 32, the controller 52 receives signals from monitors placed around the accelerator complex 30. Thus, feedback loops may be formed to optimise performance of the accelerator complex 30 and safety stops may be included, for example to switch off ion sources 32 or to close down one or all of the accelerator units 32 in response to a detected malfunction. The two-way communication of the controller 52 is indicated by the arrows 53.

The controller 52 also coordinates extraction of the proton pulses from the higher energy FFAGs 46 such that the proton pulses arrive at the multiplexer 50 at the required regularly-spaced intervals. Further details on this will be provided below.

As can be seen, the multiplexer 50 is located within the reactor complex 60 so as to be close to the reactor core 62. The interleaved proton beam produced by the multiplexer 50 travels to the reactor core 62 along a beamline 55. A diffuser may be used upstream of the reactor core 62 so as to diffuse the proton beam, thereby reducing the peak power density delivered to the target.

The reactor complex 60 is contained within protective walls 64, and the reactor core 62 may be further protected within a dome 66. The reactor core 62 may be conventional, as designs for thorium-fuelled reactors are known. For example, the reactor core 62 may contain a rod with an inner core of a spallation target, such as lead or a lead-bismuth eutectic, enclosed within a layer of thorium that will burn during the reaction process to provide a mixture including fertile thorium and fissile uranium, all contained within a blanket layer of a suitable moderator. The beamline 55 directs the proton beam to the spallation target within the rod all the time that the reactor complex 60 is operational and generating electricity. A repetition period of the proton pulses every few ms has been found to approximate a continuous wave well enough for the fission reactions to continue uninterrupted.

Heat generated by the fission reactor warms water and generates steam in heat exchangers 68. Steam produced in the heat exchangers 68 drives turbines 70 that are connected to a common shaft. Rotation of the shaft leads to generation of electricity in the generator 72. Electricity generated by the generator unit 72 is supplied to an electrical grid 74. As will be appreciated, this is a conventional arrangement and so further details will not be given.

The reactor complex 60 operates under the control of a controller 76. The controller 76 sends and receives signals, as indicated by arrows 77 in FIG. 2, to ensure safe operation of the reactor complex 60. Controllers 52 and 76 may be combined as a single unit. In addition, sensors within the reactor core 62 feed signals to the accelerator complex controller 52 such that the required proton beam is produced. In this embodiment, the temperature of the reactor core 62 is monitored and used as the primary feedback signal to the controller 52. Thus, variations in the reactor core temperature are used to adjust characteristics of the proton beam delivered by the accelerator complex 30. For example, an increasing temperature may indicate that the criticality of the fission reaction is increasing, and a corresponding reduction in proton beam current may be commanded by the controller 52.

A fraction of the electricity generated by the generator unit 72 is fed to a power supply 54 that supplies power to the various components of the accelerator complex 30. As the accelerator complex 30 must be operating to supply a proton beam to initiate the reaction in the reactor core 62, the power supply 54 also has a connection to the electrical grid 74 such that the required power may be delivered before the reactor complex 60 is generating electricity.

In this embodiment, a proton beam comprising a stream of proton pulses with a repetition period of 1 ms is produced, i.e. the proton beam has proton pulses every 1 ms to produce a near-continuous wave. Taking a general case of an accelerator complex 32 having n accelerator units 32, the controller 52 extracts a proton pulse from any particular higher energy FFAG 46 every n ms, and pauses 1 ms after extracting from one higher energy FFAG 46 before extracting from the next higher energy FFAG 46 to achieve the desired 1 kHz repetition rate. The proton beam has a current of 10 mA and an energy of 1 GeV, and so delivers a power of 10 MW. To achieve a beam current of 10 mA requires a flow of protons Nₜₒₜₐₗ of

$${N}_{total} = \frac{10 \times {10}^{- 3}}{1.602 \times {10}^{- 19}} = 6.242 \times {10}^{16} protons \text{/} second .$$

Consequently, each of the n accelerators 36 must deliver

$$\frac{1}{n} \times ( 6.242 \times {10}^{16} ) protons per second .$$

As the repetition period of each higher energy FFAG 46 is n ms, i.e. each higher energy FFAG 46 is emptied every n ms, every fill of the higher energy FFAG 46 must accumulate

$$( \frac{1}{n} \times 6.242 \times {10}^{16} ) \times ( n \times 1 \times {10}^{- 3} ) = 6.242 \times {10}^{13} protons .$$

Such a large number of protons may be comfortably accommodated in a FFAG of a reasonable size, for example having a 25 m radius. In the embodiment shown in FIGS. 2 to 4, the lower energy FFAG 34 has a radius of 15 m. At this lesser size, space charge effects in a proton train of 6.242×10¹³ protons at an injection energy such as 40 MeV will be a problem. Accordingly, protons from the lower energy FFAG 34 are transferred to the higher energy FFAG 36 with a repetition period of 1 ms. As the higher energy FFAG 36 is emptied with a repetition period of n ms, n fills of the inner FFAG 34 may be used to accumulate the 6.242×10¹³ protons in the higher energy FFAG 36. Accordingly, this brings the number of protons in the lower energy FFAG 34 to

$$\frac{1}{n} \times ( 6.242 \times {10}^{13} ) protons .$$

In the embodiment of FIGS. 2 to 4 that has three accelerator units 32 and hence n=3, this leads to a fill of 2.081×10¹³ protons in the lower energy FFAG 44 (and a repetition period of 3 ms between ejection of proton pulses from each higher energy FFAG 46). For an accelerator complex 30 having seven accelerator units 32, this reduces to 8.917×10¹² protons in the lower energy FFAG 34 (and a repetition period of 7 ms between ejection from the higher energy FFAG 36). These numbers of protons should not produce appreciable space charge effects in a 15 m radius FFAG 34, assuming a reasonable proton bunch length.

An advantage of an accelerator complex 30 comprising multiple accelerator units 32 is that a failure in any particular accelerator unit 32 may be accommodated. In particular, the specification of each accelerator unit 32 is set to be overrated for normal operation. For example, each accelerator unit may operate at 75% capacity during normal operation. This means that should one accelerator unit 32 fail, the remaining accelerator units 32 may be worked harder to make up for the shortfall. For example, to achieve the same beam current, each accelerator unit 32 may be run at a faster repetition rate or may be injected with more protons per pulse, or a mixture of the two.

For example, in the accelerator complex 30 of FIGS. 2 to 4 that has three accelerator units 32, two accelerator units 32 may continue to work should one accelerator unit 32 fail. Assuming the same beam current of 10 mA and the same repetition period of 3 ms for each accelerator unit 32 in normal operation, failure of one accelerator unit 32 can be overcome as follows. In a first scheme, the repetition period of each of the two remaining accelerator units 32 is reduced to 2 ms to provide an overall repetition period of 1 ms. The repetition rate of the inner FFAG 34 may be correspondingly increased, or the number of protons delivered in each fill increased by a factor of 1.5 to compensate (by increasing the number of ions created by the ion source 36). In a second scheme, the repetition period of the outer FFAG 36 is kept the same at 3 ms, but a greater number of protons is delivered each time the higher energy FFAG 36 is emptied (by a factor of 3/2=1.5). Again, the lower energy FFAG 34 may be emptied more frequently to accumulate more protons in the higher energy FFAG 36, or each fill of the lower energy FFAG 34 may contain more protons. As noted above, detection and response to failures are performed by the controller 52, that may co-ordinate the switch to higher beam currents/higher repetition rates in the remaining accelerator units 32.

It will be clear to the person skilled in the art that variations may be made to the above embodiments without departing from the scope of the invention that is defined by the appended claims.

1. A method of generating a composite proton beam using a proton beam generator comprising n proton beam generator units, where n is at least 2,
the method comprising, in each of the n proton beam generator units, using a negative hydrogen ion source to generate a beam of negative hydrogen ions, stripping the negative hydrogen ions to create a proton beam, accelerating the proton beam and guiding the proton beam to a common point, and
the method further comprising merging the n proton beams provided by the n proton beam generator units at the common point to form the composite proton beam.

2. The method of claim 1, wherein the n proton beams are pulsed, and the n proton beams are merged such that the proton pulses are interleaved.

3. The method of claim 2, wherein the proton pulses in the n proton beams have a substantially common repetition rate, and the proton pulses are interleaved with equal spacing between consecutive proton pulses to provide the composite proton beam with a repetition rate n times that of the n proton beams.

4. The method of claim 3 wherein, when one of the n proton beam generator units stops producing a proton beam, the method further comprises increasing the repetition rate of the proton pulses in the n−1 remaining proton beams by a factor of n/(n−1).

5. The method of claim 3, comprising generating the n proton beams to have substantially equal beam currents and, wherein when one of the n proton beam generator units stops producing a proton beam, the method further comprises increasing the beam current in the n−1 remaining proton beams by a factor of n/(n−1).

6. A method of generating electricity in an accelerator driven subcritical reactor, comprising generating a composite proton beam using a proton beam generator in accordance with the method of any preceding claim, guiding the composite proton beam to a reactor containing a spallation target and nuclear fuel, such that the proton beam strikes the spallation target thereby causing spallation of neutrons that travel into the nuclear fuel, the ensuing fission being used to generate electricity.

7. The method of claim 6, wherein the nuclear fuel is thorium, and the spallation neutrons cause the thorium to be converted to fissile uranium.

8. The method of claim 6 or claim 7, wherein energy generated by the reactor is fed back to power the proton beam generator.

9. Apparatus for generating and delivering a composite proton beam to a target, the apparatus comprising n like proton beam generator units, each of the n proton beam generator units comprising an ion source operative to generate negative hydrogen ions, a stripper arranged to strip the negative hydrogen ions to form a proton beam, an accelerator arranged to accelerate the proton beam, and wherein the apparatus is arranged to combine the n proton beams to form the composite proton beam.

10. The apparatus of claim 9, wherein the accelerator of each of the n proton beam generator units comprises a linear accelerator, a cyclotron, a synchrotron or a fixed field alternating gradient accelerator.

11. The apparatus of claim 9, wherein the accelerator of each of the n proton beam generator units comprises circular accelerators.

12. The apparatus of claim 9, wherein the accelerator of each of the n proton beam generator units comprises a first stage of acceleration followed by a circular accelerator to provide a second stage of acceleration.

13. (canceled)

14. An accelerator driven subcritical reactor comprising apparatus according to any of claims 9 to 12 operative to provide a proton beam to a spallation target located within a reactor core, the reactor core further comprising fuel arranged to receive neutrons produced during spallation.

15. The reactor of claim 14, wherein the fuel comprises thorium.
